(19) United States
(12) Patent Application Publication
(10) Pub. No.: US 2013/0170321 A1
(43) Pub. Date: Jul. 4, 2013

(54) SYSTEMS AND METHODS FOR CONTROLLING TRANSDUCER PULSE TRANSITIONS IN ULTRASOUND IMAGING

(71) Applicants: Bruno Hans Haider, Ballston Lake, NY (US); Shinichi Amemiya, Hachiouji-shi (JP)

(72) Inventors: Bruno Hans Haider, Ballston Lake, NY (US); Shinichi Amemiya, Hachiouji-shi (JP)

(73) Assignee: General Electric Company, Schenectady, NY (US)

(21) Appl. No.: 13/339,242

(22) Filed: Dec. 28, 2011

(51) Int. Cl. B06B 1/02

(52) U.S. Cl. 367/140

(57) ABSTRACT

Methods and systems for transitioning a transducer voltage between a first voltage level and a second voltage level are provided. A method includes pulling a transducer voltage to the first voltage level, pulling the transducer voltage from the first voltage level to an intermediate voltage level, and pulling the transducer voltage from the intermediate voltage level to the second voltage level. The intermediate voltage level includes an intermediate voltage level between the first voltage level and the second voltage level.

### BACKGROUND

Medical diagnostic ultrasound is an imaging modality that employs ultrasound waves to probe the acoustic properties of the body of a patient and produce a corresponding image. Generation of sound wave pulses and detection of returning echoes is typically accomplished via a plurality of transducers located in the probe. Such transducers typically include electromechanical elements capable of converting electrical energy into mechanical energy for transmission and mechanical energy back into electrical energy for receiving purposes. Some ultrasound probes include up to thousands of transducers arranged as linear arrays or a 2D matrix of elements.

When the transducers of such ultrasound probes are excited via an applied voltage to produce a suitable ultrasound beam, power is dissipated from the probe into the surrounding environment. In certain instances, the amount of power dissipation from the probe may place limitations on the allowable power dissipation from other components in the ultrasound system, thus limiting the ultrasound exam speed, image quality, and so forth. Additionally, power dissipation from the probe may give rise to other side effects, such as an increased handle temperature. Some systems have addressed this problem by incorporating active cooling systems to reduce the temperature of the electronics. However, such active cooling systems significantly contribute to the overall system cost and bulkiness.

### BRIEF DESCRIPTION

In one embodiment, an ultrasound system includes a transducer and a positive voltage switch. The positive voltage switch is adapted to be in an open position or in a closed position, and when the positive voltage switch is in the closed position, the positive voltage switch is adapted to pull the transducer to a positive voltage. The ultrasound system also includes a negative voltage switch adapted to be in an open position or in a closed position, and when the negative voltage switch is in the closed position, the negative voltage switch is adapted to pull the transducer voltage to a negative voltage. The ultrasound system also includes an intermediate voltage switch adapted to be in an open position or in a closed position, and when the intermediate voltage switch is in the closed position, the intermediate voltage switch is adapted to pull the transducer voltage to an intermediate voltage between the positive voltage and the negative voltage. Additionally, the ultrasound system also includes a controller adapted to control positions of the positive voltage switch, the negative voltage switch, and the intermediate voltage switch to generate a pulse waveform. The controller is adapted to control the intermediate voltage switch to a closed position during a transition portion of the pulse waveform in which the transducer voltage is transitioned between the positive voltage and the negative voltage.

In another embodiment, a method for transitioning a transducer voltage between a first voltage level and a second voltage level is provided. The method includes pulling a transducer voltage to the first voltage level, pulling the transducer voltage from the first voltage level to an intermediate voltage level, and pulling the transducer voltage from the intermediate voltage level to the second voltage level. The intermediate voltage level includes an intermediate voltage level between the first voltage level and the second voltage level.

In another embodiment, a computer readable medium encodes one or more executable routines, which, when executed by a processor, cause the processor to perform acts including pulling a transducer voltage to the first voltage level, pulling the transducer voltage from the first voltage level to an intermediate voltage level, and pulling the transducer voltage from the intermediate voltage level to a second voltage level. The intermediate voltage level includes an intermediate voltage level between the first voltage level and the second voltage level.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram illustrating an embodiment of an exemplary ultrasound system in accordance with aspects of presently disclosed embodiments;

FIG. 2 is a schematic diagram illustrating an embodiment of pulser circuitry that may be employed in the ultrasound system of FIG. 1;

FIG. 3 illustrates an embodiment of a method that may be implemented by a controller to pull a transducer voltage to an intermediate level and then to a final level during a pulse transition;

FIG. 4 is a schematic diagram illustrating an embodiment of switching circuitry that may be controlled to implement the embodiment of the method of FIG. 3;

FIG. 5A illustrates an embodiment of a pulse waveform that may be generated during operation of an ultrasound probe;

FIG. 5B illustrates a timing diagram indicating the position of a positive voltage switch during the pulse waveform of FIG. 5A;

FIG. 5C illustrates a timing diagram indicating the position of a negative voltage switch during the pulse waveform of FIG. 5A; and

FIG. 5D illustrates a timing diagram indicating the position of an intermediate switch during the pulse waveform of FIG. 5A.

### DETAILED DESCRIPTION

As described in detail below, provided herein are ultrasound systems having an ultrasound probe with one or more transducers that may be pulled to an intermediate level during voltage transitions in accordance with presently disclosed embodiments. That is, embodiments of the provided transducers are capable of being pulled from a starting level to an intermediate level before being pulled to a final level. For example, in one embodiment, during a negative voltage to positive voltage transition, a transducer may be pulled from the negative voltage to a ground level and then from the ground level to the positive voltage. For further example, during a positive voltage to negative voltage transition, the transducer may be pulled from the positive voltage to the ground level and then from the ground level to the negative voltage. During such voltage transitions, the transducer may be pulled to ground level or the transducer may be pulled to any intermediate level suitable for the given implementation. The foregoing feature may offer advantages over systems that pull the transducer directly from the starting level to the final level because the dissipated power associated with pulling to an intermediate level before pulling to the final level may be substantially lower than the power dissipated when pulling directly to the final level. Still further, in some embodiments, the power dissipated during a voltage transition may be further reduced by pulling the transducer to more than one intermediate level before pulling the transducer to the final level.

It should be noted that the present application makes reference to an imaging “subject” as well as an imaging “object”. These terms are not mutually exclusive and, as such, use of the terms is interchangeable and is not intended to limit the scope of the appending claims. Such terms may indicate a human or animal patient, or a device, object or component, such as in manufacturing processes.

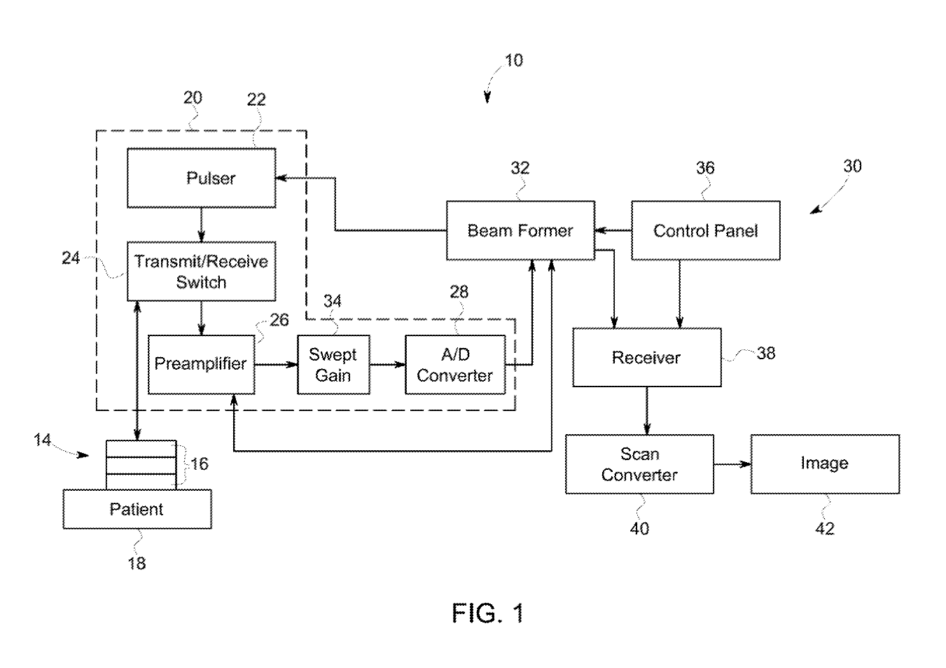

Turning now to the drawings, FIG. 1 is a block diagram illustrating an embodiment of an ultrasound system 10 capable of implementing the presently disclosed pulse transitions having reduced power dissipation. In the depicted embodiment, the ultrasound system 10 is a digital acquisition and beam former system, but in other embodiments, the ultrasound system 10 may be any suitable type of ultrasound system, not limited to the depicted type. The illustrated ultrasound system 10 includes a transducer array 14 having transducer elements 16 and being in contact with a patient or subject 18 during an imaging procedure. As will be appreciated by those skilled in the art, transducer elements 16 may be fabricated from materials, such as, but not limited to lead zirconate titanate (PZT), polyvinylidene difluoride (PVDF) and composite PZT. It should be noted that the transducer array 14 is configured as a two-way transducer and capable of transmitting ultrasound waves into and receiving such energy from the subject or patient 18. In transmission mode, the transducer array elements 16 convert the electrical energy into ultrasound waves and transmit it into the patient 18. In reception mode, the transducer array elements 16 convert the ultrasound energy received from the patient 18 (backscattered waves) into electrical signals.

Each transducer element 16 is associated with its respective transducer circuitry 20. That is, in the illustrated embodiment, each transducer element 16 in the array 14 has a pulser 22, a transmit/receive switch 24, a preamplifier 26, and an analog to digital (A/D) converter 28. For example, in an embodiment in which the transducer array 14 includes 128 transducer elements 16, there would be 128 sets of transducer circuitry 20, one for each transducer element 16.

Further, a variety of other imaging components 30 are provided to enable image formation with the ultrasound system 10. Specifically, the ultrasound system 10 also includes a beamformer 32, a swept gain 34, a control panel 36, a receiver 38, and a scan converter 40 that cooperate with the transducer circuitry 20 to produce an image 42. For example, in one embodiment, during operation of the ultrasound system 10, the image 42 is created using a pulse echo method of ultrasound production and detection. In this embodiment, a pulse is directionally transmitted into the patient 18 via the transducer array 14 and then is partially reflected from tissue interfaces that create echoes that are detected by the transducer elements 16.

More specifically, the pulser 22, which is capable of operating as a transmitter, provides an electrical voltage suitable for excitation of the transducer elements 16 and may adjust the applied voltage to control the output transmit power. The transmit/receive switch 24 is synchronized with the pulser 22 and is capable of isolating the high voltage (e.g., approximately 150 V) used for pulsing from the amplification stages during receiving cycles. The swept gain 34 reduces the dynamic range of the received signals prior to digitization. The beam former 32 is capable of providing digital focusing, steering, and summation of the beam, and the receiver 38 processes the received data for display to an operator. For example, in one embodiment, the beam former 32 may control application-specific integrated circuits (ASICs) including the transmit/receive switch 24, the A/D converter 28, the preamplifier 26, and so forth, for each of the transducer elements 16. In this way, the beam former 32 may control and generate electronic delays in the transducer array 14 to achieve the desired transmit and receive focusing, as specified by the ultrasound operational parameters input via the control panel 36. Further, the scan converter 40 receives the processed data from the receiver 38 and produces the image 42, which may be displayed to an operator, for example, on an associated monitor.

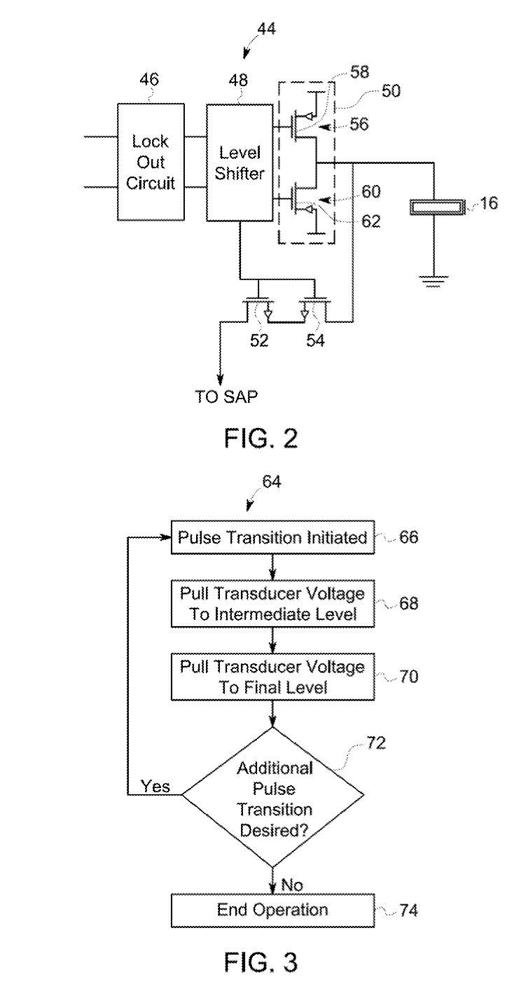

FIG. 2 illustrates an embodiment of a pulser circuit 44 that may be associated with the transducer element 16 in the ultrasound probe. That is, each transducer element 16 in the transducer array 14 may be associated with a separate pulser circuit 44. As shown, the pulser circuit 44 includes a lock out circuit 46, a level shifter 48, a pulser 50, and a pair of transistors 52 and 54 forming the TR (transmit/receive) switch. The pulser 50 includes a high voltage switch 56 configured as a transistor 58 and a low voltage switch 60 configured as a transistor 62.

During operation, the pulser circuit 44 cooperates with the transducer element 16 that it is associated with to provide the transducer element 16 with an appropriate excitation voltage during transmission of ultrasound signals into the patient 18 and to appropriately configure the transducer element 16 to receive signals back from the patient 18 during a receiving portion of the ultrasound operation. Accordingly, during a pulse cycle, the transistors 58 and 62 are activated and deactivated to pull the transducer element 16 to the desired voltage. For example, in one embodiment, the transistor 58 may be a positive voltage transistor, and the transistor 62 may be a negative voltage transistor. Accordingly, the positive voltage transistor 58 may be activated to pull the transducer element 16 to a positive voltage, and the negative voltage transistor 62 may be activated to pull the transducer element 16 to a negative voltage. Still further, in some embodiments, the positive voltage switch 56 and the negative voltage switch 60 may be controlled to function as current sources. That is, in such embodiments, the transistors 58 and 62 may be controlled to charge at a predetermined or controllable rate when activated. In this way, the transistors 58 and 62 may be controlled to generate a desired pulse in accordance with parameters of the ultrasound operation being performed.

Further, the lock out circuit 46 may be employed to reduce or eliminate the likelihood of both the transistor 58 (e.g., a positive voltage transistor) as well as the transistor 62 (e.g., a negative voltage transistor) being concurrently activated. That is, the lock out circuit 46 operates to ensure that invalid activation states of the transistors 58 and 62 are not reached in error. For example, in one embodiment, the lock out circuit 46 may operate to ensure that when the transistor 58 is activated to pull the transducer element 16 to a positive voltage, the transistor 62 remains in a deactivated state. For further example, the lock out circuit 46 may operate to ensure that when the transistor 62 is activated to pull the transducer element 16 to a negative voltage, the transistor 58 remains in a deactivated state. Still further, the level shifter 48 is provided to shift the incoming control signal from the incoming voltage range into a range that is appropriate for the transistors 58 and 62. For example, in one embodiment, the level shifter 48 may shift the incoming control signal from approximately 3.3 V to approximately 100 V.

Additionally, the transistors 52 and 54 may be operated to communicatively couple the transducer element 16 to the imaging circuit components, such as the preamplifier 26, during receiving cycles. That is, the transistors 52 and 54 may be controlled to an open state when the transducer element 16 is transmitting an ultrasound signal into the patient 18 and the transistors 52 and 54 may be controlled to a closed state when the transducer element 16 is receiving data that is communicated via the closed transistors 52 and 54 to the preamplifier 26.

FIG. 3 illustrates an embodiment of a method 64 of controlling the positive voltage switch 56 and the negative voltage switch 60 to transition the transducer element 16 between a first voltage level and a final voltage level while reducing the power dissipated by the switching transistor. The method 64 includes initiation of a pulse transition between two voltage levels (block 66). For example, a transition from a positive voltage level to a negative voltage level may be initiated, or a transition from a negative voltage level to a positive voltage level may occur. Regardless of the value of the transition levels, a pulse transition from a starting level to a final level is initiated.

The method 64 provides for pulling of the transducer voltage to an intermediate level (block 68) during the transition from the starting voltage level to the final voltage level. That is, the transducer voltage is pulled to the final level (block 70) only after first being pulled to the intermediate level (block 68). The foregoing feature may reduce the power dissipated by the switching transistor because the transition energy necessary for transitioning from the starting voltage level to the intermediate voltage level and then to the final voltage level is significantly less than the transition energy necessary for transitioning directly from the starting voltage level to the final voltage level.

For example, the power dissipation associated with a capacitor charging directly from a negative Vₒ to a positive Vₒ is given by 2*capacitance*Vₒ². However, the power dissipation associated with a capacitor charging from the negative Vₒ to a ground level, or from the ground level to the positive Vₒ, is given by ½*capacitance*Vₒ². Therefore, the power dissipation associated with a capacitor indirectly transitioning from the negative Vₒ to the positive Vₒ via the ground level is given by capacitance*Vₒ². Therefore, transitioning to an intermediate voltage level, such as the ground level, may significantly reduce the dissipated power. Additionally, it should be noted that in some embodiments, more than one intermediate voltage level may be provided to provide further reductions in the dissipated power.

In the illustrated method 64, once the transducer voltage is pulled to the final level (block 70) and the transition between the starting voltage and the final voltage is therefore achieved, the method 64 proceeds by checking if an additional pulse transition is desired (block 72). If desired, the transducer voltage may be further transitioned from the previous final level to a new desired level, again utilizing an intermediate voltage level during the transition to reduce the dissipated power. Once the desired pulse transitions have been completed, the operation is ended (block 74).

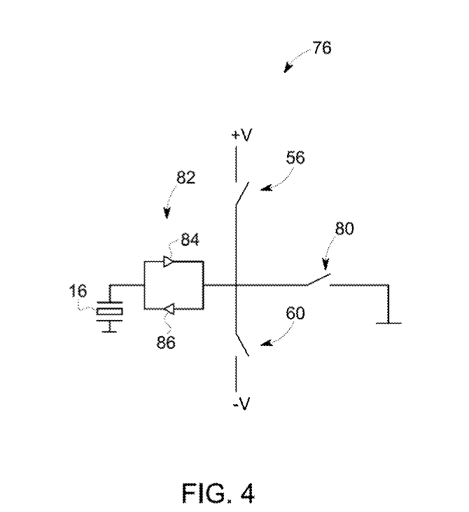

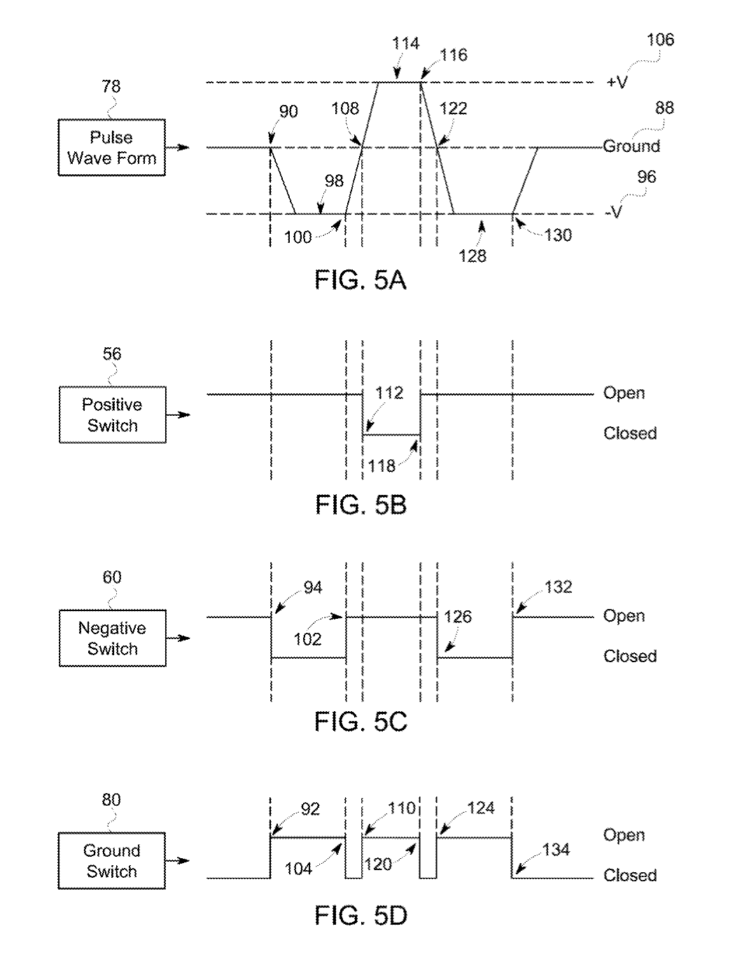

FIG. 4 illustrates an embodiment of a circuit 76 that may be operated to implement the method 64 of FIG. 3 and generate an embodiment of a pulse waveform 78 shown in FIG. 5A. As shown in FIG. 4, the circuit 76 includes the positive voltage switch 56, the negative voltage switch 60, a ground switch 80, and a pair 82 of anti-parallel diodes 84 and 86. In some embodiments, the positive voltage switch 56, the negative voltage switch 60, and the intermediate voltage switch 80 may be configured to function as current sources. That is, in such embodiments, the switches may be controlled to provide a predetermined or controllable current when activated.

FIG. 5A illustrates the example pulse waveform 78 that is generated when the positive voltage switch 56, the negative voltage switch 60, and the ground switch 80 are controlled according to the timing diagrams shown in FIGS. 5B, 5C, and 5D. It should be noted that the illustrated circuit 76 and the timing diagrams are merely examples and are subject to a variety of implementation-specific variations according to the pulse waveform desired for the given ultrasound procedure. Indeed, such diagrams are merely illustrative of one manner in which the transducer element 16 may be pulled to one or more intermediate levels during a voltage transition and are not meant to limit embodiments of the foregoing systems and methods.

Turning now to the illustrated example, initially, the pulse waveform indicates that the voltage level of the transducer element 16 is approximately equal to a ground level 88, and, accordingly, the ground switch 80 is in a closed position while the negative switch 60 and the positive switch 56 remain in open positions. However, at a first transition point 90 on the pulse waveform 78, the ground switch 80 opens at transition point 92, and the negative switch 60 closes at transition point 94 to pull the transducer to a negative voltage level 92, as shown in portion 98 of the pulse waveform 78.

Subsequently, at transition point 100 on the pulse waveform 78, a pulse transition from the negative voltage 96 to a positive voltage 106 is initiated. However, as described in the method 64 of FIG. 3, the transducer voltage is first pulled to ground level 88 before being pulled to the positive voltage level 106 to reduce the power dissipation associated with the switching transistors. It should be noted that although in the illustrated embodiment, the transducer voltage is pulled to ground level 88 before being pulled to the positive voltage level 106, in other embodiments, the transducer voltage may be pulled to any suitable intermediate level, not limited to the ground level 88, or to any quantity of desired intermediate levels.

In the depicted embodiment, the negative switch 60 opens at transition point 102, and the ground switch closes at transition point 104 to pull the transducer voltage to ground level 88, which is the intermediate level in this embodiment. Shortly before or at approximately point 108 on the pulse waveform 78, the ground switch 80 is opened at point 110, and the positive switch 56 is closed at point 112 to pull the transducer voltage from the ground level 88 to the positive voltage level 106. The pulse waveform 78 remains at the positive voltage level 106 during portion 114 of the waveform.

Subsequently, at transition point 116, a pulse transition from the positive voltage level 106 to the negative voltage level 96 is initiated. Here again, during the transition between voltage levels, the transducer voltage is pulled first to ground level 88, which serves as an intermediate level, before being pulled to the desired voltage level. Specifically, the positive switch 56 opens at point 118, and the ground switch 80 closes at point 120 to pull the transducer voltage to the ground level 88. Shortly before or at point 122 on the pulse waveform 78, the ground switch 80 opens at point 124, and the negative switch 60 closes at point 126. The pulse waveform 78 then remains at the negative voltage level 96 during the waveform portion 128. Finally, at transition point 130, the transducer voltage is again pulled to ground level 88 by opening the negative switch 60 at point 132 and closing the ground switch 80 at point 134.

It should be noted that the illustrated embodiments are merely examples of switches that may be utilized to pull the transducer voltage to one or more intermediate levels during transitions between a starting voltage level and a final voltage level. However, a variety of suitable circuitry may be utilized in other embodiments. For example, in one alternate embodiment, the intermediate switch (e.g., ground switch 80) may be more than one switch. In one particular embodiment, the intermediate switch may be made up of a first switch capable of being utilized, for example, for positive to negative voltage transitions, and a second switch capable of being utilized, for example, for negative to positive voltage transitions. In such an embodiment, each of the first switch and the second switch may be operational in a single direction, for example, through a diode.

For further example, in such an embodiment, during a positive to negative voltage transition, the transducer voltage initially begins at the positive voltage level. The ground switch may then close to pull the transducer voltage to the ground level. Subsequently, when the negative switch closes, the ground switch may remain closed without further affecting the transducer voltage because the ground switch is effectively deactivated because a series diode is provided to substantially prevent current from flowing the in opposite direction. Again, the described embodiments are merely examples, and a variety of circuits may be utilized to pull the transducer voltage to a suitable intermediate level during voltage transitions, thus reducing power dissipation.

This written description uses examples to disclose the relevant subject matter, including the best mode, and also to enable any person skilled in the art to practice the present approach, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An ultrasound system, comprising:
a transducer;
a positive voltage switch configured to be in an open position or in a closed position, wherein when the positive voltage switch is in the closed position, the positive voltage switch is configured to pull the transducer to a positive voltage;
a negative voltage switch configured to be in an open position or in a closed position, wherein when the negative voltage switch is in the closed position, the negative voltage switch is configured to pull the transducer voltage to a negative voltage;
an intermediate voltage switch configured to be in an open position or in a closed position, wherein when the intermediate voltage switch is in the closed position, the intermediate voltage switch is configured to pull the transducer voltage to an intermediate voltage between the positive voltage and the negative voltage; and
a controller configured to control positions of the positive voltage switch, the negative voltage switch, and the intermediate voltage switch to generate a pulse waveform, wherein the controller is configured to control the intermediate voltage switch to a closed position during a transition portion of the pulse waveform in which the transducer voltage is transitioned between the positive voltage and the negative voltage.

2. The ultrasound system of claim 1, wherein the intermediate voltage switch comprises a ground switch configured to be in the open position or in the closed position to pull the transducer voltage to ground.

3. The ultrasound system of claim 1, wherein the controller is further configured to employ lock-out logic to control only one of the positive voltage switch and the negative voltage switch to be in a closed position at a time.

4. The ultrasound system of claim 1, wherein the transition portion of the pulse waveform comprises a transition from the negative voltage to the positive voltage.

5. The ultrasound system of claim 1, comprising a plurality of additional intermediate voltage switches, each configured to be in an open position or in a closed position to pull the transducer voltage to a plurality of additional intermediate voltages between the positive voltage and the negative voltage.

6. The ultrasound system of claim 5, wherein the controller is configured to sequentially control each of the plurality of additional inter mediate voltage switches to a closed position during a transition portion of the pulse waveform in which the transducer voltage is transitioned between the positive voltage and the negative voltage.

7. The ultrasound system of claim 1, wherein the positive voltage switch comprises a first transistor, and the negative voltage switch comprises a second transistor.

8. The ultrasound system of claim 7, wherein the controller is configured to control the first transistor to ramp up to the positive voltage at a first controlled rate and to control the second transistor to ramp down to the negative voltage at a second controlled rate.

9. The ultrasound system of claim 1, comprising a second intermediate voltage switch configured to be in an open position or in a closed position, and wherein the intermediate voltage switch is configured to be controlled by the controller to a closed position during a transition from the positive voltage to the negative voltage, and the second intermediate switch is configured to be controlled by the controller to a closed position during a transition from the negative voltage to the positive voltage.

10. A method for transitioning a transducer voltage between a first voltage level and a second voltage level, comprising:
pulling a transducer voltage to the first voltage level;
pulling the transducer voltage from the first voltage level to an intermediate voltage level; and
pulling the transducer voltage from the intermediate voltage level to the second voltage level, wherein the intermediate voltage level comprises an intermediate voltage level between the first voltage level and the second voltage level.

11. The method of claim 10, comprising pulling the transducer voltage from the intermediate voltage level to a second intermediate voltage level, wherein the second intermediate voltage level comprises a voltage level between the intermediate voltage level and the second voltage level.

12. The method of claim 10, wherein pulling the transducer voltage to the first voltage level comprises closing a positive voltage switch, pulling the transducer voltage to the intermediate voltage level comprises closing a ground switch, and pulling the transducer voltage to the second voltage level comprises closing a negative voltage switch.

13. The method of claim 10, wherein the intermediate voltage level comprises a ground level.

14. The method of claim 10, comprising pulling the transducer voltage from the first voltage level to a second intermediate voltage level, wherein the second intermediate voltage level comprises a voltage level between the first voltage level and the intermediate voltage level.

15. The method of claim 10, wherein pulling the transducer voltage to the first voltage level comprises closing a negative voltage switch, pulling the transducer voltage to the intermediate voltage level comprises closing a ground switch, and pulling the transducer voltage to the second voltage level comprises closing a positive voltage switch.

16. A computer readable medium encoding one or more executable routines, which, when executed by a processor, cause the processor to perform acts comprising:
pulling a transducer voltage to the first voltage level;
pulling the transducer voltage from the first voltage level to an intermediate voltage level; and
pulling the transducer voltage from the intermediate voltage level to a second voltage level, wherein the intermediate voltage level comprises an intermediate voltage level between the first voltage level and the second voltage level.

17. The computer readable medium of claim 16, wherein pulling the transducer voltage to the intermediate voltage level comprises pulling the transducer voltage to ground.

18. The computer readable medium of claim 16, wherein pulling the transducer voltage to the first voltage level comprises pulling the transducer voltage to a negative voltage level by switching a negative switch to a closed position.

19. The computer readable medium of claim 16, wherein pulling the transducer voltage to the second voltage level comprises pulling the transducer voltage to a positive voltage level by switching a positive switch to a closed position.

20. The tangible machine readable medium of claim 16, comprising pulling the transducer voltage from the intermediate voltage level to a second intermediate voltage level, wherein the second intermediate voltage level comprises a voltage level between the intermediate voltage level and the second voltage level.
